(19) United States
(12) Patent Application Publication
(10) Pub. No.: US 2016/0188761 A1
(43) Pub. Date: Jun. 30, 2016

(54) Asynchronous Parallel Simulation Protocol for Stream Processing Platforms

(71) Applicant: Universidad de Santiago de Chile, Santiago (CL)

(72) Inventors: Verónica Gil-Costa, Santiago (CL); Carolina Bonacic, Santiago (CL); Mauricio Marin, Santiago (CL)

(21) Appl. No.: 14/583,224

(22) Filed: Dec. 26, 2014

(51) Int. Cl. G06F 17/50

(52) U.S. Cl. CPC G06F 17/5009

(57) ABSTRACT

An asynchronous parallel simulation protocol useful to simulate events in a stream processing platform. The invention is a windowing scheme which is suitable for distributed stream computing platforms containing facilities for supporting fully asynchronous processing elements and downstream event flows. It is a realization of the concept of a BSP superstep based oracle simulator that enables using statistics from the recent past to conduct the actual optimistic simulation at low rate of straggler messages. The invention is capable of achieving good statistic agreement with results from sequential simulations of the same models.

### BACKGROUND OF THE INVENTION

1. Field of the Invention

The present invention relates to asynchronous parallel simulation executed on a stream processing platform.

2. Brief Summary of the Invention

The present invention includes an asynchronous parallel simulation protocol for stream processing platforms. In a sequential simulation all events are executed in chronological order and a single clock is updated after the execution of each event. In parallel simulations this becomes a main difficulty as events are processed in different processors, and each processor has its own local clock.

The presented protocol is capable of reducing the number of straggler events (events executed in a non-chronological order) using two time control barriers: (1) The first one is a time window barrier (B) used to process events with timestamps within the time window. (2) The second one is an oracle time barrier (R) used to compute and update a superstep counter. Both barriers are computed complete asynchronously.

### BRIEF DESCRIPTION OF DRAWINGS

For a filler understanding of the invention, reference should be made to the following detailed descriptions, taken in consideration with the accompanying drawings, in which:

FIG. 1 Shows an example of an application execution on the stream processing platform.

FIG. 2. Shows the general organization of threads and processors in the BSP model.

FIG. 3. Is a diagrammatic view of the steps of the Asynchronous Parallel Simulation Protocol for Stream Processing Platforms.

### DETAILED DESCRIPTION OF THE PREFERRED EMBODIMENT

Provided is an efficient in running time and memory usage windowing scheme suitable for distributed stream computing platforms containing facilities for supporting fully asynchronous processing elements and downstream event flows. The scheme is based on two barriers to control the advance of timestamped events. (1) The first one is a time window barrier (B) used to process events with timestamps within the time window. (2) The second one is an oracle time barrier (R) used to compute and update a superstep counter.

The stream processing world-view is that streams are passed through a graph (DAG) formed by processing elements (PEs) which are connected each other in a downstream manner. Each PE performs a given primitive operation on the receiving stream and may generate one or more output streams. Streams take the form of a collection of “events” that are “emitted” by upstream PEs to create more refined streams containing data for downstream PEs. Stream events are tuples (e, v, d) where e is the type of event, v is a value associated to the e, and d is data associated to e. Upon reception of an upstream event, the respective PE executes user code which receives the incoming event as input so that it can perform computations on it and emit new events to feed the downstream flow of events. The S4 platform makes the deployment of PEs on the cluster of processors transparent and enables their efficient parallel and distributed execution.

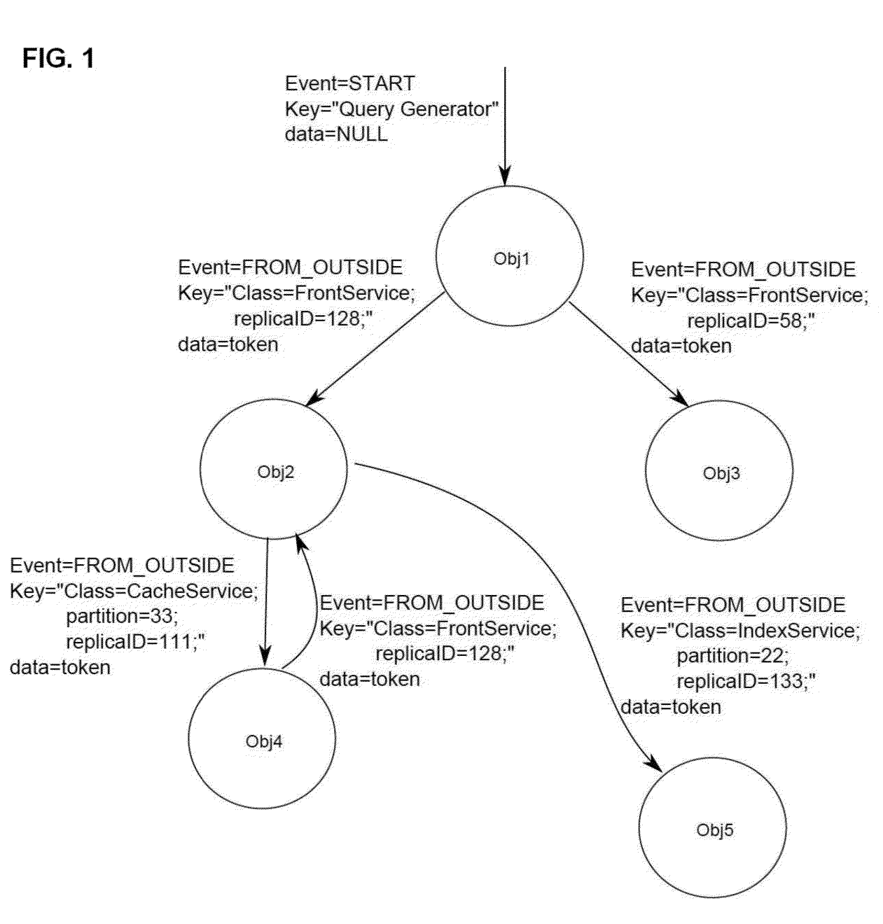

The typical content of a key is a string like “class=Class-Name; instance=ID”, say“class=FrontService; replica=128”, or “class=IndexService; partitionID=22; replicaID=133”. In this example, the only requirement is to specify the class identification field to instantiate the right PE. FIG. 1 shows an example where the initial key is generated with the START event which creates a Query Generator object. The other objects are created as soon as the query generator sends events to them.

Parallel discrete event simulation (PDES) provides an efficient tool to evaluate the performance of large scale systems, and they can be used to deal with the complexities of understanding and optimizing those systems. A PDES program consists of a collection of logical processes or LPs, each simulating a different component of the model system being simulated. LPs communicate to each other by exchanging timestamped event messages

There are two synchronization strategies widely used. Optimistic simulation represented by the Time Warp (TW) protocol and its many variations [1], and a number of conservative protocols [2]. TW is capable of processing events in parallel in correct chronological order by optimistically processing the occurrence of events available in processors and correcting errors that are timely detected. When TW detects that the simulation of events have been missed in the chronological simulation time, a reverse computation called roll-back is executed in the involved processors to re-simulate previous events and to include the missed events in the right chronological order. On the other hand, the conservative protocols ensure safe simulation events by imposing rules on the time of the next events that prevent the late arrival of events in the processors. To this end, the simulation in any given LP is blocked until it can be guaranteed that no event with a smaller timestamp will later be received in the LP.

The Asynchronous Parallel Simulation Protocol for Stream Processing Platforms removes the roll-back mechanism while applying a windowing scheme to restrain optimistic simulation time advance, so that the rate of potential roll-backs is kept very low. This leads to approximate simulations. The rewards are simulations of large and complex models that run very fast on clusters of processors which enable their application to on-line capacity planning studies.

The Asynchronous Parallel Simulation Protocol for Stream Processing Platforms is bases on the use of two barriers: 1) a window barrier named B and 2) a superstep counter barrier named R. The R barrier is used to estimate the number of supersteps executed by the simulation when running in a synchronous way. Thus, the R barrier helps to bring the asynchronous simulation close to the synchronous simulation which tends to reduce the number of stragglers events, (events executed in a non-chronological order). In particular, when the simulation is design on the parallel computing model named Bulk Synchronous Parallel (BSP) computing model. Under the BSP model, computation is organized as a sequence of supersteps. During a superstep, processors may perform computations on local data and/or send messages to other processors. At the end of a superstep there is always a synchronization barrier. It permits that messages sent during the current superstep are available for processing at their destinations at the next superstep. The underlying communication library ensures that all messages will be available at their destinations before starting the next superstep. In each processor there is one master thread that synchronizes with all other P-1 master threads to execute the BSP supersteps and exchange messages. Then, in each processor and superstep the remaining T-1 threads synchronize with the master thread to start the next superstep, though they may immediately exchange messages during the current superstep as they share the same processor main memory.

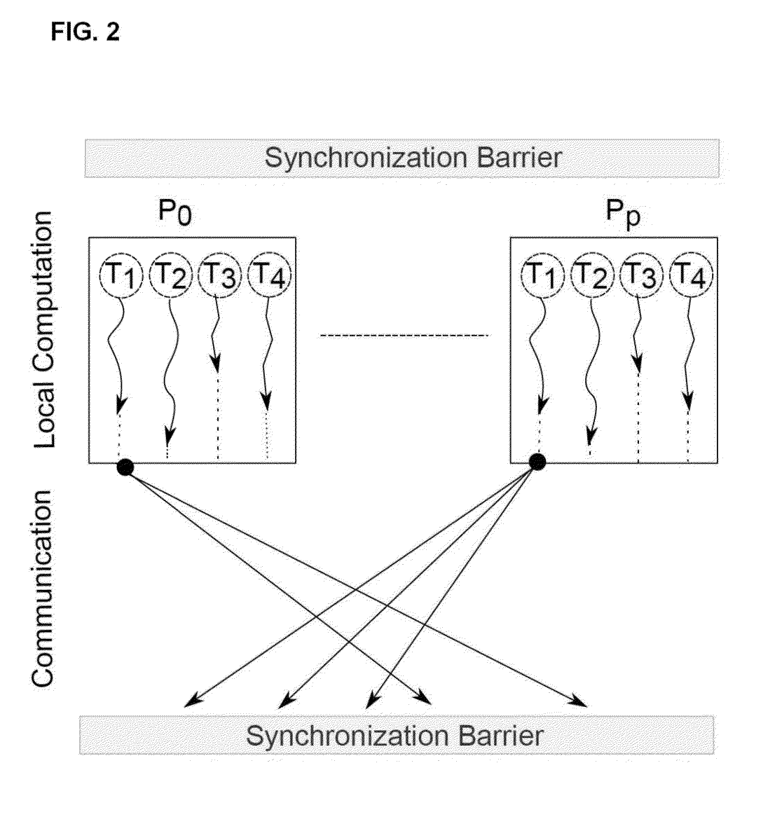

FIG. 2 shows the general organization of threads and processors based on the BSP model.

The invention works as follows. The global virtual time (GVT) is defined as the event with the least time across all T×P kernel event lists. Each event e stores the simulation time at which e is created (ts) and the occurrence time of the event (tr).

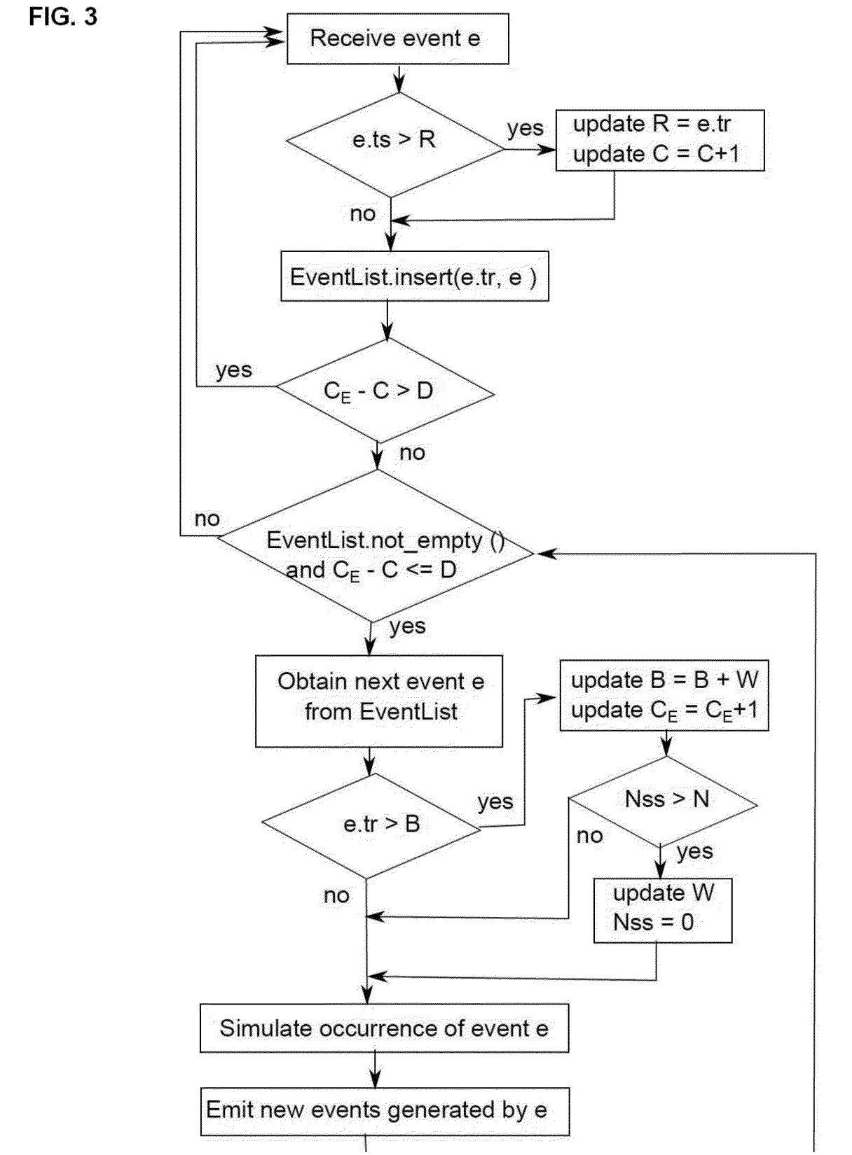

FIG. 3 shows the general steps followed by the Asynchronous Parallel Simulation Protocol for Stream Processing Platforms.

After receiving a new event e, the algorithm checks whether the creation time of the event e.ts is greater than the current oracle time barrier R. If so, R is updated with the time of occurrence of the event (e.ts) and the number of oracle supersteps is increased. Then, the event e is inserted into the EventList, which is sorted by the occurrence time of the events e.tr. Initially, C=0.

If the difference between the real number of supersteps of the PE (CE) and the estimated number of supersteps (C) is greater than a user defined value (D), the event e is not simulated and the control flow of the algorithm goes back to the first step to wait for another incoming event. Otherwise, the first event of the EventList is recovered (the event with the lowest time of occurrence). The initial value of CE=0.

If the time of occurrence of the event (e.tr) is greater than the window barrier time (B), it means that the simulation has reached the global barrier synchronization (all processors have reached the same point of execution of the simulated algorithm), and the window barrier is updated. The initial value of B=0. With this instruction the simulation time is advanced W units of time. The value of W is computed as W=f(G/C) with f>=1. C is the oracle superstep counter in the PE and G is the elapsed time since the last update of W. W is updated after N supersteps.

Also, the number of real supersteps is increased by one. Finally, the event is simulated and the algorithm emits the new events generated by e.

### Hardware and Software Infrastructure Examples

The present invention may be embodied on various multi-core computing platforms. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic magnetic, optical, electromagnetic, infrared, or semiconductor system, apparatus or device, or any suitable combination of the foregoing. More specific examples (a non-exhaustive list) of the computer readable storage medium would include the following: an electronic connection having one or more wires, a portable computer diskette, a hard disk, a random access memory (RAM), a read-only memory (ROM), an erasable programmable read-only memory (EPROM or Flash memory), an optical fiber, or any suitable combination of the foregoing. In the context of this document, a computer readable storage medium maybe any tangible medium that contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of variety of forms, including, but not limited to, electro-magnetic, optical, or any suitable combination thereof. A computer readable signal maybe any computer readable medium that is not computer readable storage medium, and that can communicate, propagate, or transport a program for use by or in connection with an instruction execution system, apparatus, or device.

Program code embodied on a computer readable medium maybe transmitted using any appropriate medium, including but not limited to, wire-line, optical fiber cable, radio frequency, etc., or any suitable combination of the foregoing. Computer program code for carrying out operations for aspects of the present invention may be writing in any combination of one or more programming languages, including an object oriented programming language such as Java, C++ or the like and conventional procedural programming languages such as the “C” programming language or similar programming languages.

Aspects of the present invention are described below with the reference to the flowchart illustration and/or block diagrams of methods, apparatus (systems) and computer program products according to the embodiments of the invention. It will be understood that each block of the flowchart illustrations and/or block diagrams, can be implemented by computer program instructions. These computer program instructions may be provided to a processor or a general purpose computer, or the programmable data processing apparatus to produce a machine, such that the instructions, which execute via the processor of the computer or other programmable data processing apparatus, creates means for implementing the functions/acts specified in the flowchart and/or block diagram block or blocks.

These computer programmable instructions may also be stored in a computer readable medium that can direct a computer, other programmable data processing apparatus, or other devices to function in a particular manner, such that the instructions stored in the computer readable medium produce an article of manufacturing including instructions which implement the function/act specified in the flowchart and/or block diagram block or blocks.

The computer program instructions may be also loaded onto a computer, other programmable data processing apparatus, or other devices to cause a series of operational steps to be performed on a computer, other programmable apparatus, or other devices to produce a computer implemented process such that the instructions which execute on the computer or other programmable apparatus provide process for implementing the functions/acts specified in the flowchart and/or block diagram block or blocks.

Glossary of Claim Terms:

GVT: Global virtual time, defined as the event with the least time in the simulation.

Oracle Barrier (R): Barrier used to compute and update a superstep counter in each PE.

PDES: Parallel discrete event simulation.

PE: Processing elements.

Stragglers: events executed in a non-chronological order.

TW: Time Warp parallel simulation protocol.

Window barrier (B): Barrier used to process events with timestamps within the time window. Avoids processing events beyond a given time, to reduce the number of straggler events.

The advantages set forth and above, and those made apparent from the foregoing description, are efficiently attained. Since certain change may be made in the above construction without departing from the scope of the invention, it is intended that all matters contained in the foregoing description or shown in the accompanying drawings shall be interpreted as illustrative and not in a limiting sense.

What is claimed is:

1. The asynchronous parallel simulation protocol method for stream processing platforms based on a time window barrier (B) used to process events with timestamps within the time window; and on an oracle time barrier (R) used to compute and update a superstep counter, comprising the steps of:
a. inputting an event;
b. if the creation time of the event is greater than the current oracle time barrier R, then updating R with the time of occurrence of the event and increasing the number of oracle supersteps;
c. inserting the event into an EventList data structure, this is sorted by the occurrence time of the events;
d. if the difference between the real number of supersteps of the PE (CE) and the estimated number of supersteps (C) is greater than a user defined value (D), then returning to beginning and waiting for another incoming event;
e. recovering the first event of the EventList;
f. if the time of occurrence of the event is greater than the window barrier time, then updating the window barrier B and the real number of supersteps of the PE;
g. if the number of supersteps is greater than N, the calculating W=f(G/C) with f>=1 where C is the oracle superstep counter in the PE and G is the elapsed time since the last update of W; and
h. simulating the event.

2. The method according to claim 1, wherein the system has the capability to be adapted to other parallel computing platforms, like cluster of computers and multi-thread computers.
